(19) United States
(12) Patent Application Publication
(10) Pub. No.: US 2014/0322619 A1
(43) Pub. Date: Oct. 30, 2014

(54) FUEL CELL SYSTEM

(71) Applicant: Ballard Power Systems Inc., Burnaby (CA)

(72) Inventors: Yao LIN, Hartford, CT (US); Kazuo SAITO, Glastonbury, CT (US); Raghothama Madhusudana RAO, Manchester, CT (US); Sandeep Kisan GOUD, West Hartford, CT (US)

(21) Appl. No.: 13/872,232

(22) Filed: Apr. 29, 2013

(51) Int. Cl. H01M 8/04; H01M 8/10; H01M 8/06

(52) U.S. Cl. CPC H01M 8/04014; H01M 8/0675; H01M 8/04097; H01M 8/04067; H01M 8/10
USPC 429/410

(57) ABSTRACT

According to an embodiment, a fuel cell system includes an anode supply circuit is configured for delivering an anode source fluid to anode components. The anode supply circuit includes a primary supply path, a desulfurizer situated along the primary supply path, and a pre-reformer downstream of the desulfurizer and upstream of the anode components. The pre-reformer converts a portion of anode source fluid into an anode reactant and yields a reformed source fluid that includes the anode reactant. A first feedback path carries anode exhaust fluid from the anode components such that at least some heat associated with the anode exhaust fluid facilitates the pre-reformer converting at least some anode source fluid into the anode reactant. A second feedback path carries at least a portion of the reformed source fluid to be mixed with the anode source fluid provided to the desulfurizer.

This invention was made with U.S. Government support under Contract No. DE-NT0003894 awarded by the Department of Energy. The Government has certain rights in this invention.

BACKGROUND

Fuel cells are useful for generating electricity. Fuel cell components facilitate an electrochemical reaction between reactants such as hydrogen and oxygen. Some fuel cell systems, such as solid oxide fuel cell systems, can use raw natural gas as a fuel source. It is challenging to obtain hydrogen from the natural gas in an effective and efficient manner. The chemical processes required for removing sulfur and high hydrocarbons from the natural gas and converting methane into hydrogen typically require hydrogen and steam. Additionally, the heat associated with the conversion process often should be carefully managed. Typical arrangements include accumulators and steam system components, which add to the expenses associated with a fuel cell system.

### SUMMARY

According to an embodiment, a fuel cell system includes a cell stack assembly having a plurality of anode components and a plurality of cathode components. An anode supply circuit is configured for delivering an anode source fluid to the anode components. The anode supply circuit includes a primary supply path comprising at least one conduit having a downstream end near the anode components. The anode supply circuit also includes a desulfurizer situated along the primary supply path. A pre-reformer is situated along the primary supply path downstream of the desulfurizer and upstream of the anode components. The pre-reformer is configured to convert a portion of the anode source fluid into an anode reactant and to yield a reformed source fluid that includes the anode reactant. The anode supply circuit includes a first feedback path situated to carry anode exhaust fluid from the anode components to a first location where at least some heat associated with the anode exhaust fluid facilitates the pre-reformer converting at least some of the received anode source fluid into the anode reactant. A second feedback path is situated to carry at least a portion of the reformed source fluid to a second location where the portion of the reformed source fluid is mixed with the anode source fluid provided to the desulfurizer.

A method, according to an embodiment that includes a cell stack assembly having a plurality of anode components and a plurality of cathode components, includes delivering an anode source fluid to the anode components using an anode supply circuit that includes a desulfurizer and a pre-reformer situated along the primary supply path downstream of the desulfurizer and upstream of the anode components. A portion of the anode source fluid is converted in the pre-former into an anode reactant to yield a reformed source fluid that includes the anode reactant. Anode exhaust fluid is provided from the anode components through a first feedback path to a first location where at least some heat associated with the anode exhaust fluid is useful for facilitating the pre-reformer converting at least some of the received anode source fluid into the anode reactant. At least a portion of the reformed source fluid is provided through a second feedback path to a second location where the portion of the reformed source fluid is mixed with the anode source fluid provided to the desulfurizer.

Various aspects of disclosed example embodiments will become apparent to those skilled in the art from the following detailed description. The drawings that accompany the detailed description can be briefly described as follows.

### BRIEF DESCRIPTION OF THE DRAWINGS

FIG. 1 schematically illustrates selected portions of a fuel cell system designed according to an embodiment of this invention.

FIG. 2 schematically illustrates selected portions of another fuel cell system designed according to an embodiment of this invention.

### DETAILED DESCRIPTION

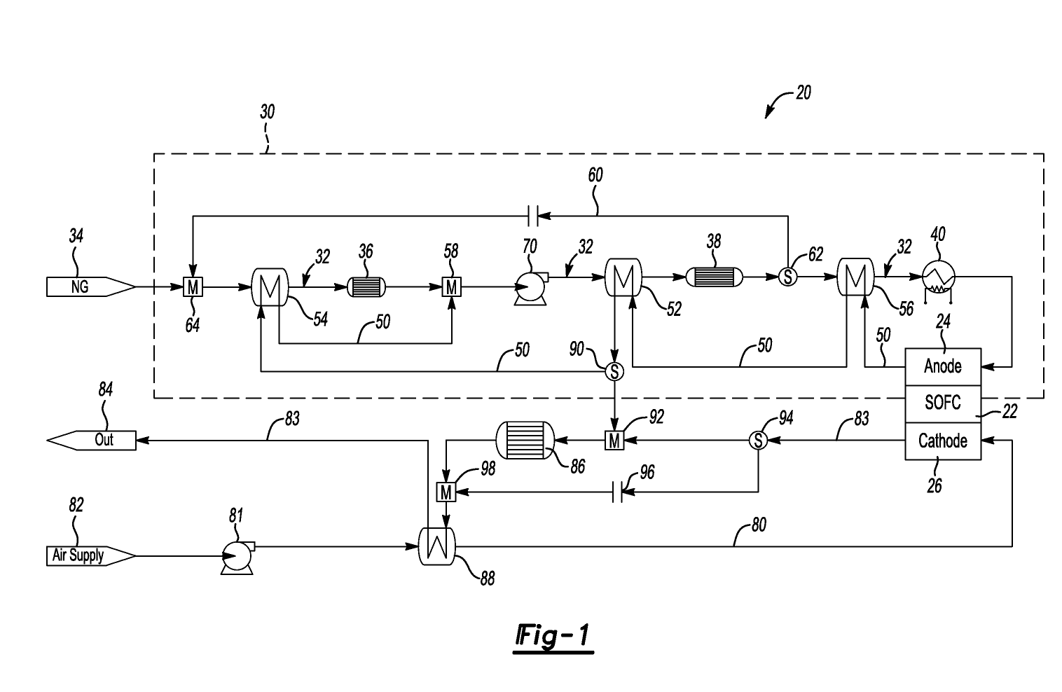

FIG. 1 schematically illustrates a fuel cell system 20. A cell stack assembly 22 includes a plurality of anode components 24 and a plurality of cathode components 26 that are used in a known manner for facilitating an electrochemical reaction for generating electricity. In the illustrated example, the fuel cell system comprises a solid oxide fuel cell system.

An anode supply circuit 30 includes a primary supply path 32 comprising at least one conduit for carrying an anode source fluid from a source 34 to the anode components 24. In one example, the anode source fluid comprises natural gas and the source 34 is a conventional source of natural gas.

The primary supply path 32 includes a desulfurizer 36. In one example, the desulfurizer is a hydro-desulfurizer (HDS). The desulfurizer 36 removes sulfur from the anode source fluid before that fluid is provided to a pre-reformer 38 along the primary supply path 32. The pre-reformer 38 removes at least some high hydrocarbons and converts at least some methane (CH₄) into hydrogen. The output from the pre-reformer 38 may be considered a reformed source fluid because at least some of the source fluid has been converted into hydrogen, which is the fuel for the anode components 24. An electric heater 40 is included in the example of FIG. 1 for warming the reformed source fluid provided to the anode components 24.

In one example, the pre-reformer 38 is configured to convert about 20% of the methane within the anode source fluid into hydrogen. A substantial portion (e.g., approximately 80%) of the methane in the anode source fluid is converted into hydrogen in the cell stack assembly 22. Converting methane into hydrogen inside of the cell stack assembly 22 reduces the methane reforming burden of the fuel processing system components that are external to the cell stack assembly 22. Another feature of converting methane into hydrogen within the cell stack assembly 22 is that it facilitates maintaining stack temperature within a desired range because of the endothermic reaction during the conversion process. There are known techniques for converting methane into hydrogen within a cell stack assembly. One example embodiment of this invention includes such a known technique.

The anode supply circuit 30 includes a first feedback path 50 to provide additional heating of the fluid within the anode supply circuit 30. The first feedback path 50 is configured to carry anode exhaust fluid from the anode components 24 to a first location along the primary path 32 where heat associated with the anode exhaust fluid is useful for warming the fluid provided to the pre-reformer 38. In the example of FIG. 1, a heat exchanger 52 is situated at the first location, which is upstream of the pre-reformer 38. In another example, the first feedback path 50 directs at least some anode exhaust to a portion of the pre-reformer 38 that is configured to receive the exhaust fluid in a manner that facilitates the conversion at the pre-reformer.

One feature of the first feedback path 50 is that it directs steam and excess hydrogen from the anode components and utilizes the heat of the steam for facilitating the reforming reaction within the pre-reformer 38 and to otherwise warm fluid within the anode supply circuit 30. Such a use of the steam exhausted from the anode components 24 contributes to meeting the pre-reformer demand for steam and increases the overall fuel utilization ratio, which enhances the electrical efficiency of the fuel cell system 20.

In the illustrated example, the first feedback path 50 includes a desulfurizer heat exchanger 54 situated upstream of the desulfurizer 36. The heat exchanger 54 facilitates warming fluid provided to the desulfurizer 36.

Another heat exchanger 56 is situated downstream of the pre-reformer 38 and upstream of the anode components 24 to facilitate warming the source fluid before it is heated by the electric heater 40.

The example of FIG. 1 includes a second feedback path 60 that directs at least some of the reformed source fluid through a splitter 62 downstream of the pre-reformer 38 to a second location where the fluid in the second feedback path 60 may be introduced into the desulfurizer 36. The example of FIG. 1 includes a mixer 64 at the second location, which is upstream of the desulfurizer heat exchanger 54. The reformed supply fluid within the second feedback path 60 has a higher hydrogen content compared to the anode exhaust fluid along the first feedback path 50. Additionally, the fluid from the second feedback path 60 has a lower steam or carbon dioxide concentration compared to fluid from the anode exhaust fluid along the first feedback path 50.

An anode fluid moving assembly 70 directs fluid within the anode supply circuit 30 in a desired manner. In the example of FIG. 1, the anode fluid moving assembly 70 comprises a single blower that is configured to urge the anode source fluid along the primary supply path 32 toward the anode components, urge the anode exhaust fluid along the first feedback path 50 and urge the portion of the reformed source fluid along the second feedback path 60. Utilizing a single anode blower in an arrangement like the embodiment of FIG. 1 can provide efficiencies by, for example, reducing the number of components required for operating the fuel cell system 20.

A cathode supply path 80 includes a blower 81 for directing a cathode supply fluid from a source 82 to the cathode components 26. In one example, the cathode supply fluid comprises air and oxygen is the reactant utilized in the cathode components 26 for facilitating the electrochemical reaction for generating electricity. A cathode exhaust path 83 carries cathode exhaust away from the cathode components 26 to a vent or outlet 84. The cathode exhaust path 83 in this example includes a burner 86 and a cathode heat exchanger 88. In one example, the burner 86 is a catalytic burner.

The first feedback path 50 includes a splitter 90 for at least selectively directing some of the anode exhaust fluid to a mixer 92 where the anode exhaust fluid is mixed with the cathode exhaust flowing to the burner 86. The hydrogen and carbon monoxide from the anode exhaust fluid are burned in the burner 86. The heat associated with the reaction in the burner 86 provides heat within the heat exchanger 88 for warming the air or other cathode supply fluid provided to the cathode components 26.

The example of FIG. 1 includes a splitter 94, bypass orifice 96 and mixer 98 for controlling the flow through the heat exchanger 88 to maintain proper cell stack assembly temperature. For example, the air temperature provided to the cathode components 26 is desirably maintained within a range such that the air is useful for coolant within the cell stack assembly 22 in addition to being the source of the cathode reactant (i.e., oxygen).

The example of FIG. 1 includes several features that enhance the efficiency and reliability of the fuel cell system 20. The two feedback paths 50, 60 take advantage of fluids available within the system for enhancing the efficiency of the system. For example, the steam from the anode exhaust utilized for facilitating the conversion into hydrogen that takes place in the pre-reformer 38 at least reduces, and in the illustrated example eliminates, the requirement for any external steam generation. For example, components such as an accumulator and related steam system components need not be included in the arrangement of the example of FIG. 1. Eliminating such components reduces the cost of the fuel cell system and enhances system efficiency. Additionally, rather than merely exhausting the steam in the anode exhaust fluid, the heat of that steam is used within the heat exchangers for achieving desired fluid temperatures within the supply circuit 30.

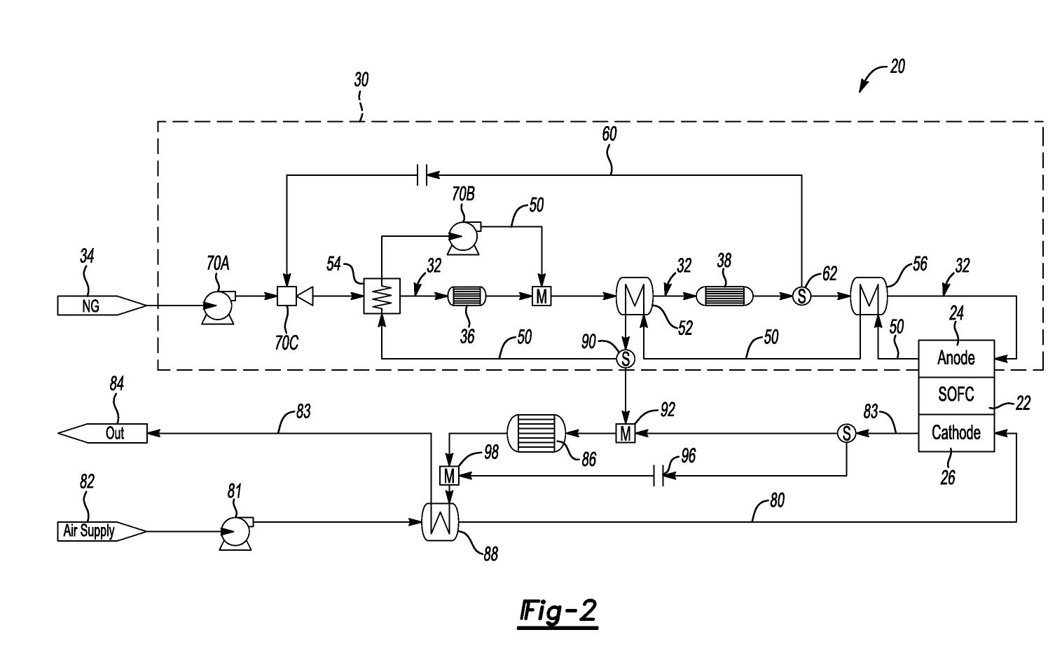

While the example of FIG. 1 includes a single blower as part of the anode fluid moving assembly 70, the example of FIG. 2 includes a primary flow path blower 70A for directing the source fluid from the source 34 along the primary path 32. A dedicated recycle blower 70B is provided along the first feedback path 50 for directing the anode exhaust fluid along the first feedback path 50. A booster and ejector device 70C enables the flow of reformed source fluid along the second feedback path 60 for providing the reformed fluid as part of the fluid provided to the desulfurizer 36. Otherwise, the example of FIG. 2 operates in the same manner as the example of FIG. 1 as described above.

The preceding description is illustrative rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A fuel cell system, comprising:
a cell stack assembly including a plurality of anode components and a plurality of cathode components; and
an anode supply circuit configured for delivering an anode source fluid to the anode components, the anode supply circuit including
a primary supply path comprising at least one conduit having a downstream end near the anode components,
a desulfurizer situated along the primary supply path,
a pre-reformer situated along the primary supply path downstream of the desulfurizer and upstream of the anode components, the pre-reformer being configured to convert a portion of the anode source fluid into an anode reactant and to yield a reformed source fluid that includes the anode reactant,
a first feedback path situated to carry anode exhaust fluid from the anode components to a first location where at least some heat associated with the anode exhaust fluid facilitates the pre-reformer converting at least some of the received anode source fluid into the anode reactant, and
a second feedback path situated to carry at least a portion of the reformed source fluid to a second location where the portion of the reformed source fluid is mixed with the anode source fluid provided to the desulfurizer.

2. The fuel cell system of claim 1, wherein the first feedback path comprises a first mixer situated to introduce the anode exhaust fluid from the first feedback path into the primary supply path downstream of the desulfurizer and upstream of the pre-reformer.

3. The fuel cell system of claim 1, wherein the first feedback path comprises at least one heat exchanger situated to facilitate heat associated with the anode exhaust gas warming at least some fluid of the primary supply path.

4. The fuel cell system of claim 3, wherein
the heat exchanger is situated at the first location; and
the first location is either upstream of the pre-reformer or at the pre-reformer.

5. The fuel cell system of claim 4, wherein the first feedback path comprises a second heat exchanger upstream of the desulfurizer for warming fluid of the primary supply path before the warmed fluid is received by the desulfurizer.

6. The fuel cell system of claim 5, wherein the second location is upstream of the second heat exchanger.

7. The fuel cell system of claim 4, wherein the first feedback path comprises a second heat exchanger downstream of the pre-reformer and upstream of the anode components for warming fluid of the primary supply path before the warmed fluid is received by the anode components.

8. The fuel cell system of claim 1, comprising:
a cathode source fluid supply path having a downstream end near the cathode components;
a cathode exhaust path configured to direct cathode exhaust fluid away from the cathode components toward a cathode exhaust outlet, the cathode exhaust path including a cathode heat exchanger situated to facilitate heat associated with the cathode exhaust fluid warming cathode source fluid upstream of the cathode components.

9. The fuel cell system of claim 8, wherein
the cathode exhaust path comprises a burner upstream of the cathode heat exchanger; and
the first feedback path is at least selectively coupled with the cathode exhaust path for introducing at least some of the anode exhaust fluid into the burner.

10. The fuel cell system of claim 1, comprising an anode fluid moving assembly including a single anode blower configured to
urge the anode source fluid along the primary supply path toward the anode components,
urge the anode exhaust fluid along the first feedback path, and
urge the portion of the reformed source fluid along the second feedback path.

11. The fuel cell system of claim 10, wherein the single anode blower is situated downstream of the desulfurizer and upstream of the pre-reformer.

12. The fuel cell system of claim 1, comprising an anode fluid moving assembly including
a first blower on the first feedback path;
a second blower on the primary supply path upstream of the desulfurizer; and
a booster-ejector device on the second feedback path upstream of the desulfurizer.

13. The fuel cell system of claim 1, wherein
the cell stack assembly comprises a solid oxide fuel cell assembly; and
the source fluid received by the cell stack assembly is converted into the anode reactant in the cell stack assembly.

14. A method of operating a fuel cell system including a cell stack assembly having a plurality of anode components and a plurality of cathode components, the method comprising the steps of:
delivering an anode source fluid to the anode components along an anode supply circuit that includes a desulfurizer situated along a primary supply path and a pre-reformer situated along the primary supply path downstream of the desulfurizer and upstream of the anode components;
converting a portion of the anode source fluid in the pre-reformer into an anode reactant to yield a reformed source fluid that includes the anode reactant;
providing anode exhaust fluid from the anode components through a first feedback path to a first location where at least some heat associated with the anode exhaust fluid is useful for facilitating the pre-reformer converting at least some of the received anode source fluid into the anode reactant, and
providing at least a portion of the reformed source fluid through a second feedback path to a second location where the portion of the reformed source fluid is mixed with the anode source fluid provided to the desulfurizer.

15. The method of claim 14, comprising introducing the anode exhaust fluid from the first feedback path into the primary supply path downstream of the desulfurizer and upstream of the pre-reformer.

16. The method of claim 14, comprising warming fluid of the primary supply path downstream of the pre-reformer and upstream of the anode.

17. The method of claim 14, comprising:
providing a cathode source fluid to the cathode components;
directing cathode exhaust fluid along a cathode exhaust path away from the cathode components toward a cathode exhaust outlet; and
warming at least some of the cathode source fluid upstream of the cathode components using heat associated with the cathode exhaust fluid.

18. The method of claim 17, wherein the cathode exhaust path comprises a burner; and
the method comprises introducing at least some of the anode exhaust fluid into the burner.

19. The method of claim 14, wherein the cell stack assembly comprises a solid oxide fuel cell assembly; and
the method comprises converting the source fluid received by the cell stack assembly into the anode reactant in the cell stack assembly.
